(19) United States
(12) Patent Application Publication
(10) Pub. No.: US 2008/0187900 A1
(43) Pub. Date: Aug. 7, 2008

(54) Foam writing pad

(75) Inventor: John C. Hardt, Belton, TX (US)

Correspondence Address: NATH & ASSOCIATES, PLLC, 112 South West Street, Alexandria, VA, 22314, US

(73) Assignee: MOORECO, L.P., Temple, TX (US)

(21) Appl. No.: 11/700,857

(22) Filed: Feb. 1, 2007

(51) Int. Cl. B43L 1/00; A47B 97/04

(52) U.S. Cl. 434/408; 248/441.1

(57) ABSTRACT

Disclosed is a foam writing pad. An embodiment of the foam writing pad includes a foam body, a writable and erasable surface that is adhered to the foam body, and an elongate through-hole within the foam. The foam body of the foam writing pad also includes a substantially planar first surface that has a writing surface receiving section therein. An attachment tab is located within the foam writing surface and connects to and retains the writable and erasable surface in the writing surface receiving section.

### FIELD OF THE INVENTION

This invention is related to a lightweight foam writing pad.

### BACKGROUND

Dry erase boards and tackable display boards are old in the art. These boards usually may have a tackable surface, such as cork or fiber, and a markable surface, such as melamine, porcelain coated paper, metal or film. The tackable surface preferably permits a note or display to be attached to the board by a push pin, thumb tack or other attachment means. The pin or tack may be removed to permit mounting of another note or display on the tackable surface. Further, the markable surface may be erased with an eraser or wiped with a cloth, to permit another marking to be made on the markable surface.

### SUMMARY OF THE INVENTIVE ASPECTS

The present invention is directed to a lightweight foam writing pad. An embodiment of the present invention is a writing surface surrounded by a foam body. This embodiment includes a foam body, a writable and erasable surface that is adhered to the foam body, and an elongate through-hole within the foam body. The elongate through-hole is unimpeded by the writable and erasable surface. Variations on this embodiment are such that the writable and erasable surface is magnetically adhered to the foam body. The foam body of the foam writing pad can also include a substantially planar first surface. The substantially planar first surface has a writing surface receiving section that has at least one attachment tab therein. The attachment tab connects to and retains the writable and erasable surface in the writing surface receiving section. The attachment tab can be magnetic and the writable and erasable surface can be metal. Or, the writable and erasable surface can be adhered to the foam body by an adhesive, in which case the attachment tab, or some part thereof, would be an adhesive. The writable and erasable surface can be a dry-erase surface.

Another embodiment of the present invention is a foam writing pad that includes a retaining lip. Such a foam writing pad includes a foam body that has a substantially planar first surface, and a writable and erasable surface that is adhered to the substantially planar first surface of the foam body. The substantially planar first surface includes a writing surface receiving section that has a first retaining lip and a second retaining lip. The second retaining lip opposes the first retaining lip.

The writable and erasable surface should be somewhat flexible so that it can collapse to fit within the first and second retaining lips. The writable and erasable surface is retained in the writing surface receiving section by the first and second retaining lips. The writable and erasable surface can be adhered to and surrounded by the foam body. Also, the foam writing pad can include a ferrous material that is dispersed throughout an interior of the foam body. An advantage to including a ferrous material within the foam body is the potential magnetization of the foam body to attach the foam body to a metal surface or to attach a metal writable and erasable surface to the foam body. Thus, an alternate configuration of the foam writing pad is such that the writable and erasable surface is comprised of a ferrous material that can be magnetically adhered to the foam body. The writable and erasable surface can be a chalk board, a dry-erase board, a cork board or a paper writing surface or any combination thereof.

A further embodiment of the inventive foam writing pad includes a slide-in feature. Such a foam writing pad includes a foam body that has a writing surface receiving section accessible by an access slit in one side of the foam body, and a writable and erasable surface that is slidingly engagable with the foam body through the access slit. The writable and erasable surface can be a chalk board, a dry-erase board, a cork board or a paper writing surface, any combination thereof.

This embodiment of the foam writing pad has a substantially planar first surface, having a writing surface receiving section. The writing surface receiving section has at least one attachment tab therein. The attachment tab connects to and retains the writable and erasable surface in the writing surface receiving section.

Variations of this embodiment of the inventive foam writing pad include the writable and erasable surface being magnetically adhered to the foam body. The attachment tab can also be magnetic to enable magnetic adherence. In this case, the writable and erasable surface should be metal to facilitate use of the magnetism. Alternatively, the attachment tab can be metal and the writable and erasable surface would be magnetic.

In a situation where it is less advantageous to use magnetic adherence, the writable and erasable surface can be adhered to the foam body using an adhesive. In this situation, the attachment tab can be an adhesive.

### DESCRIPTION OF THE DRAWINGS

FIG. 1A shows an embodiment of the inventive foam writing pad;

FIG. 1B shows the embodiment of FIG. 1A of the foam writing pad with a writing surface partially removed to reveal a writing surface receiving section;

FIG. 1C shows the embodiment of the foam writing pad of FIG. 1A with a writing surface completely removed to reveal a writing surface receiving section and an attachment tab;

FIG. 2 shows another embodiment of the inventive foam writing pad; and

FIG. 3 shows a further embodiment of the inventive foam writing pad.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

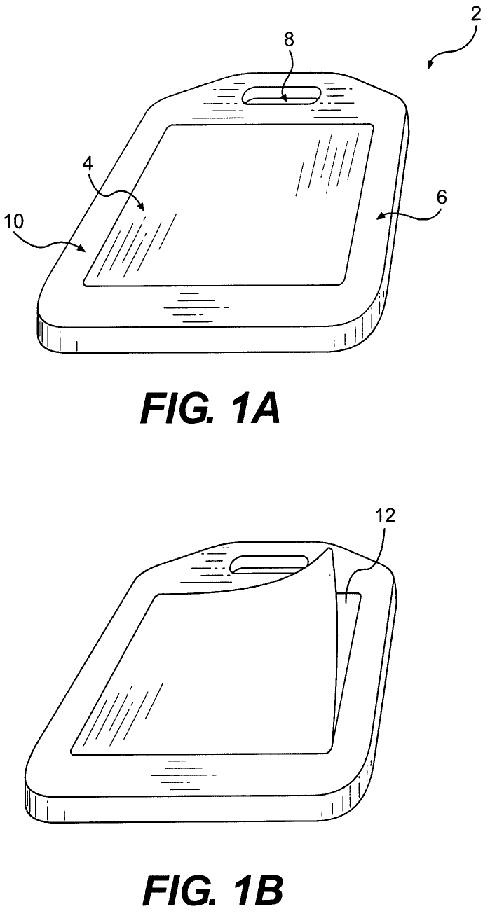

As shown in FIG. 1A, an exemplary embodiment of the present invention is a foam writing pad 2 having a writable and erasable surface 4 surrounded by and adhered to a foam body 6. An elongate through-hole 8 is positioned within the foam body 6. The elongate through-hole 8 is unimpeded by the writable and erasable surface 4 and can serve as a handle for holding the foam writing pad elongate through-hole 8 can also serve as a relief for hanging the foam writing pad on a hook.

With reference to FIGS. 1B and 1C, the writable and erasable surface 4 is magnetically adhered to the foam body 6. The foam body 6 of this embodiment of the foam writing pad 2 includes a substantially planar first surface 10 having an attachment tab 14, which can be magnetic, embedded therein. A magnet that opposes the attachment tab 14 can be placed on the writable and erasable surface 4; or, the writable and erasable surface can include a metallic material. The substantially planar first surface 10 has a writing surface receiving section 12 underneath the writable and erasable surface 4. As shown in FIG. 1C, additional attachment tabs 14a and 14b can be added to the writing surface receiving section 12. The attachment tab 14 and the additional attachment tabs 14a and 14b can all be magnetic or can all be adhesive or can be some combination thereof. The writable and erasable surface 4 can be a dry-erase surface, a chalkboard surface, a paper surface, any combination thereof, or any other surface that is suitable for writing and erasing and that can be combined with metal to adhere to a magnetic surface.

The foam body 6 is lightweight relative to the writable and erasable surface 4. Preferably, the foam body will be less than 0.5 lbs. The foam body should weigh as little as possible such that a toddler or similarly sized person between the ages of 3-8 can lift it with one hand. In a non-limiting use, a child writes answers on the writable and erasable surface 4 of the foam writing pad 2 in response to a question from a teacher during a lesson. The lightweight feature of the foam body 6 allows the child in this non-limiting example to quickly write an answer and hold the foam writing pad over his head using the through-hole 8 to show the teacher the proposed answer.

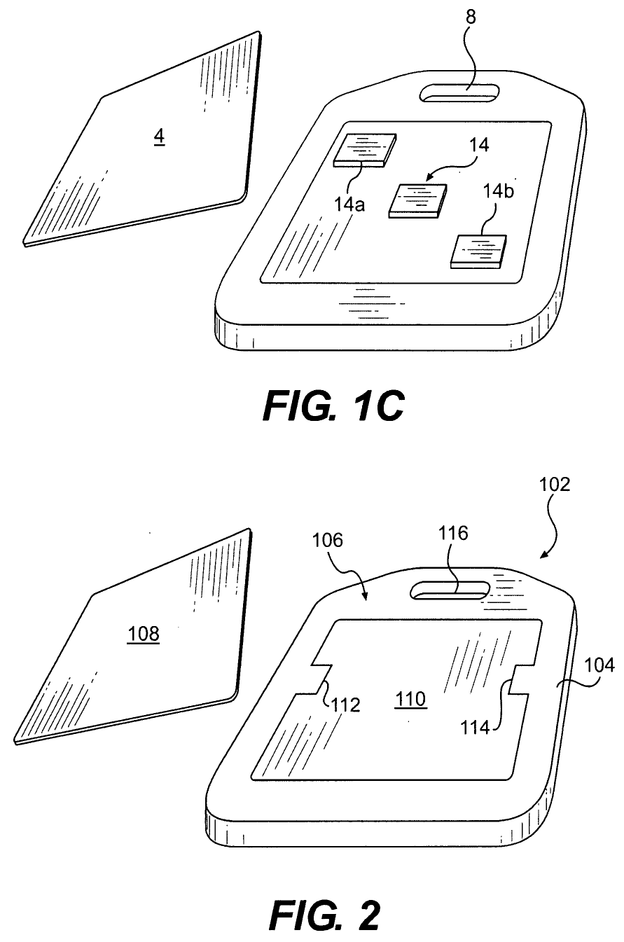

As shown in FIG. 2, another exemplary embodiment of the foam writing pad 102 includes a foam body 104 that has a substantially planar first surface 106. An integral handle 116 is included in the foam body. The integral handle shown in FIG. 2 and in other figures is a through-hole; however, the integral handle is not limited to a through-hole. The integral handle can also be a recess within the substantially planar first surface 106 that does not extend all of the way through the foam writing pad 102. A recess provides enhanced gripping ability for a person carrying the foam writing pad 102.

A writable and erasable surface 108 is attachable to the substantially planar first surface 106 of the foam body 104. The substantially planar first surface 106 includes a writing surface receiving section 110 that has a first retaining lip 112 and a second retaining lip 114. The writing surface receiving section 110 is sized to snugly and matingly accommodate the writable and erasable surface 108 so that the writable and erasable surface is at least flush with the first surface 106 of the foam body 104. The second retaining lip 114 opposes the first retaining lip 112. The writable and erasable surface 108 should be flexible so that it can easily fit into the writing surface receiving section 110. The writable and erasable surface 108 is retained in the writing surface receiving section 110 by the first retaining lip 112 and the second retaining lip 114. The retaining lips 112 and 114 clamp down on the writable and erasable surface 108, thereby urging the writable and erasable surface 108 toward the writing surface receiving section 110.

Alternatively, the retaining lips 112 and 114 can be made removable from the substantially planar first surface 106. For example, alternative removable retaining lips will include a pin (not shown) that can be inserted into a recess in the foam body 104. With removable retaining lips, the writable and erasable surface 108 does not need to be flexible; rather, it can simply be placed into the writing surface receiving section 110 and the removable retaining lips 112 and 114 can be placed over it.

As a further alternative, the foam writing pad 102 can include a ferrous material such as metal filings, strips or chips, within the interior of the foam body 108 or on the surface of the foam body 108. In the case of metal filings or chips and smaller strips, the ferrous material is dispersed throughout an interior of the foam body 104. An advantage of including a ferrous material within the foam body 108 is the potential magnetization of the foam body 104 to attach the foam body 104 to a metal surface or to attach a metal writable and erasable surface to the foam body 104. Thus, this alternate configuration of the foam writing pad 102 is such that the writable and erasable surface 108 is comprised of a ferrous material thereby allowing it to be magnetically adhered to the foam body 104. This configuration is advantageous for students. If a student wishes to save the information written on the writable and erasable surface 108, it can be removed and stored so it is not mistakenly erased.

In another alternative, rather than the writable and erasable surface 108 being removable, it can be permanently adhered to the foam body 104 using an adhesive; or it can be manufactured within the foam body such that it is surrounded by the foam body 104, thereby securing it in place. The writable and erasable surface 108 can be a chalk board, a dry-erase board, a cork board, a paper writing surface or any combination thereof. If a student wishes to save or protect the information written on the writable and erasable surface 108 from being inadvertently erased, a cover can be placed over the surface. For example, a student can place a second metallic surface over the writable and erasable surface 108 and magnetically adhere the second metallic surface to the foam body 104 when the foam body contains a ferrous material. Alternatively, a hinged flap, which protects the writable and erasable surface when not in use and which, by way of a hinge, can be easily moved for access to the writable and erasable surface, can be included in the foam body 204.

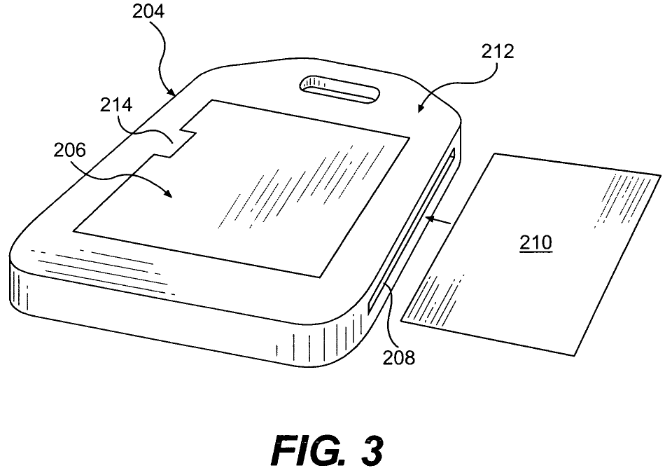

A further exemplary embodiment of the foam writing pad 202 is shown in FIG. 3 and includes a slide-in feature. This embodiment of the foam writing pad 202 includes a foam body 204 having a writing surface receiving section 206 that is accessible by an access slit 208 in at least one side of the foam body 204, and a writable and erasable surface 210 that is slidingly engagable with the foam body 204 through the access slit 208. The writable and erasable surface 210 can be a chalk board, a dry-erase board, a cork board, a paper writing surface or any combination thereof.

This embodiment of the foam writing pad 202 has a substantially planar first surface 212 in which the writing surface receiving section 206 is located. The writing surface receiving section 206 has at least one attachment tab 214 therein. The attachment tab 214 connects to and retains the writable and erasable surface 210 in the writing surface receiving section 206.

Variations of the foam writing pad include the writable and erasable surface 210 being magnetically adherable to the foam body 204. The attachment tab 214 can be a magnet to enable magnetic adherence of the writable and erasable surface 210. In this case, the writable and erasable surface 210 will be metal. Alternatively, the attachment tab 214 can be metal and the writable and erasable surface 210 would then be magnetic or would at least have a magnetic component.

In a situation where it is less advantageous to use magnetic adherence, the writable and erasable surface 210 can be adhesively adhered to the foam body 204. In this situation, the attachment tab 214 will include an adhesive to keep the writable and erasable surface 210 in place.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. For example, one or more elements can be rearranged and/or combined, or additional elements may be added. Thus, the present invention is not intended to be limited to the embodiments shown herein but is to be accorded the widest scope consistent with the principles and novel features disclosed herein.

I claim:

1. A foam writing pad comprising:
a foam body,
a writable and erasable surface that is adhered to said foam body, and
an elongate through-hole within said foam body, said elongate through-hole being unimpeded by said writable and erasable surface.

2. The foam writing pad as recited in claim 1 wherein said writable and erasable surface is magnetically adhered to said foam body.

3. The foam writing pad as recited in claim 2 further comprising a substantially planar first surface, said substantially planar first surface having a writing surface receiving section that has at least one attachment tab therein which connects to and retains said writable and erasable surface in said writing surface receiving section.

4. The foam writing pad as recited in claim 3 wherein said attachment tab is magnetic and said writable and erasable surface is metal.

5. The foam writing pad as recited in claim 3 wherein said attachment tab is metal and said writable and erasable surface is magnetic.

6. The foam writing pad as recited in claim 3 wherein said writable and erasable surface is adhered to said foam body using an adhesive.

7. The foam writing pad as recited in claim 3 wherein said attachment tab is an adhesive.

8. The foam writing pad as recited in claim 1 wherein said writable and erasable surface is a dry-erase surface.

9. A foam writing pad comprising:
a foam body having a substantially planar first surface; and
a writable and erasable surface that is adhered to said substantially planar first surface of said foam body;
wherein said substantially planar first surface comprises a writing surface receiving section having a first retaining lip and a second retaining lip, said second retaining lip opposing said first retaining lip.

10. The foam writing pad as recited in claim 9 wherein said writable and erasable surface is retained in said writing surface receiving section by said first and second retaining lips.

11. The foam writing pad as recited in claim 10 wherein said writable and erasable surface is adhered to and surrounded by said foam body.

12. The foam writing pad as recited in claim 9 wherein said foam body comprises a ferrous material dispersed throughout an interior of said foam body.

13. The foam writing pad as recited in claim 12 wherein said writable and erasable surface is comprised of a ferrous material and is magnetically adhered to said foam body.

14. The foam writing pad as recited in claim 9 wherein said writable and erasable surface is selected from the group consisting of a chalk board, a dry-erase board, a cork board, a paper writing surface and combinations thereof.

15. A foam writing pad comprising:
a foam body having a writing surface receiving section accessible by an access slit in one side of said foam body, and
a writable and erasable surface that is slidingly engageable with said foam body through said access slit.

16. The foam writing pad as recited in claim 15 wherein said writable and erasable surface is magnetically adhered to said foam body.

17. The foam writing pad as recited in claim 16 further comprising a substantially planar first surface, said substantially planar first surface having a writing surface receiving section that has at least one attachment tab therein which connects to and retains said writable and erasable surface in said writing surface receiving section.

18. A foam writing pad as recited in claim 17 wherein said attachment tab is magnetic and said writable and erasable surface is metal.

19. A foam writing pad as recited in claim 17 wherein said attachment tab is metal and said writable and erasable surface is magnetic.

20. The foam writing pad as recited in claim 17 wherein said writable and erasable surface is adhered to said foam body using an adhesive.

21. A foam writing pad as recited in claim 20 wherein said attachment tab is an adhesive.

22. The foam writing pad as recited in claim 15 wherein said writable and erasable surface is selected from the group consisting of a chalk board, a dry-erase board, a cork board, a paper writing surface and combinations thereof.
